(19) United States
(12) Patent Application Publication
(10) Pub. No.: US 2014/0236055 A1
(43) Pub. Date: Aug. 21, 2014

(54) RESUSCITATION DEVICE

(71) Applicant: KONINKLIJKE PHILIPS N.V., EINDHOVEN (NL)

(72) Inventors: Pierre Hermanus Woerlee, Valkenswaard (NL); Paul Aelen, Eindhoven (NL)

(21) Appl. No.: 14/350,120

(22) PCT Filed: Nov. 6, 2012
(86) PCT No.: PCT/IB2012/056180

§ 371 Date: Apr. 7, 2014

Related U.S. Application Data
(60) Provisional application No. 61/556,855, filed on Nov. 8, 2011.

(51) Int. Cl. A61H 31/00

(52) U.S. Cl. CPC A61H 31/00
USPC 601/41

(57) ABSTRACT

The present invention relates to an apparatus (10) for performing cardiopulmonary resuscitation comprising a resuscitation device configured for autonomously performing cardiopulmonary resuscitation, a stimulation device (12) configured for stimulating the endothelial function including nitric oxide synthase pathway in a patient in need thereof, and a controller for controlling the resuscitation device and/or the stimulation device.

### FIELD OF THE INVENTION

The present invention relates to a resuscitation device and a method for operating a resuscitation device.

### BACKGROUND OF THE INVENTION

Cardiac arrest (CA) is one of the main causes of death in the western world. After the heart has stopped pumping, death is unavoidable unless acute medical care is available. The resulting ischemia disturbs a wide range of cell processes; this eventually leads to cell death. It has been reported that the probability for survival after cardiac arrest decreases exponentially with time. After about 4 minutes the condition of heart and brain is deteriorated to such an extent that a minimum amount of perfusion (induced by for instance CPR or other means) is required to restore the cells and organs before further treatment (i.e. defibrillation) can be applied. Unfortunately the perfusion by CPR is very low even if done perfectly; hence further ischemia and cell damage during CPR is very likely.

A detrimental phenomenon which occurs after perfusion is restored (after Return of Spontaneous Circulation, ROSC) is so-called reperfusion damage. This is caused by providing oxygen and nutrients to cells which are in a bad condition due to a long (>3-4 minutes) duration ischemia. From the 30-40% of the victims of CA that have ROSC roughly two third die due to this phenomenon. On average only 10% of all CA victims survive, many have an impaired neurological function. Hence there is a very high mortality rate after ROSC. There is a large need for treatment that reduces reperfusion damage and increase survival with good neurological outcome.

Recently research has indicated that reperfusion damage can be reduced by applying mild hypothermia (i.e. rapid cooling to 33° C.). This method has received class I recommendation by ILCOR. However, hypothermia is difficult to apply rapidly during cardiac arrest.

In the present description, a technique is discussed that can be used to increase both micro perfusion during CPR and reduce reperfusion damage after ROSC resulting in an improved outcome of cardiac arrest treatment. The proposed device enhances shear stress related emission of cardio- and neuro-protective endogenous substances from the endothelial lining of the (large) vessels (aorta, venae cava . . . ). Application of the technique before, during or after a period of reduced or negligible perfusion may have a positive influence on the degree of reperfusion damage and hence on CPR outcome. It is well known that the endothelial lining of the vessels emit substances when triggered by shear stress, these in turn cause local vasodilatation by relaxing the vascular smooth muscle, influence the inflammatory system in a positive way and reduce blood clothing and adhesion of lymphocytes on the vessel wall.

For CPR, vasodilation of the arterioles and capillaries in the heart and brain is very important, among others it causes better perfusion of the heart and brain (by reduced flow resistance) during CPR and therefore reduces ischemia. The vasodilation is mainly caused by NO emission due to the conversion of L-arginine by three different nitric oxide synthases enzymes (NOS). Other substances emitted due to shear stress (like prostacyclin, thromboxane) are claimed to have a beneficial influence on platelet aggregation. In the coronary vessels endothelial-dependent hyperpolarizing factor is released with subsequent significant coronary vasodilation. Tissue plasminogen activator is also released, it has a function in the dissolution of blood cloths. Of special interest is reduction of clothing in the micro-circulation in the brain and heart. Hence high shear stress on the endothelial lining of large vessels in the proper frequency range is desirable during CPR.

Due to the low-flow during CPR there is a very low shear stress and hence reduced emission of these endogenous substances. There is also a lack of blood oxygenation, which further slows down the NOS synthase pathway. This reduced emission of NO and other substances may cause vasoconstriction and enhances other detrimental processes (such as blood clothing, etc). Hence it is important to enhance the shear stress on the vessel lining both during and after CPR (due to pulsatile blood flow or other means),It is also important to induce sufficient oxygenated blood flow. Since CPR itself is not well suited to generate the required shear stress in the vessel lining other methods have been proposed.

It has been proposed to use whole body shaking in the head-to-toe direction. Typical shaking parameters are a frequency of a few Hz (optimum 3-6 Hz) and accelerations around 1 g. The so-called p-Gz CPR has shown superior results on (neurological) outcome in animal tests of ventricular fibrillation. This group has also shown both in vitro and in vivo that pGz shaking enhances NO and shear stress related endogenous substances emission. Adams has noted that pGz CPR alone is not sufficient and additional manual or mechanical CPR is required (U.S. Pat. No. 6,878,123). The pGz CPR method is not very practical for use during CPR and can also be dangerous for some patients. Therefore a simpler method to induce shear stress related emission of NO and related substances is highly required.

It is known that (ultra) sound (US) or vibrations can have therapeutic action on some physiological processes such as wound healing, bone growth and increase in perfusion. The frequency range where therapeutic action occurs is very wide from audio frequencies (kHz) to MHz's. Also there are claims that therapeutic US can reduce reperfusion damage after myocardial infarction and stroke. The mechanisms related to this reduced reperfusion damage are claimed to be similar to the ones described by Sackner for pGz CPR, i.e. US, sound or vibration can induce shear stress in the endothelial linings of large vessels and body cavities. There are many studies that demonstrated biological activity induced by US, both in vitro and in vivo.

The inventor of the present invention has appreciated that an improved automatic resuscitation device is of benefit, that treatment to reduce reperfusion damage is needed already during resuscitation treatment and integration with high quality resuscitation devices/methods (e.g. automated CPR, hypothermia devices) is needed and has in consequence devised the present invention.

### SUMMARY OF THE INVENTION

It would be advantageous to achieve a device providing an increased likelihood of surviving cardiac arrest and at the same time ensuring that the device is easy to use for a non-skilled person.

In general, the invention preferably seeks to mitigate, alleviate or eliminate one or more of the above mentioned disadvantages singly or in any combination. In particular, it may be seen as an object of the present invention to provide a method that solves the above mentioned problems, or other problems, of the prior art.

To better address one or more of these concerns, in a first aspect of the invention an apparatus for performing cardiopulmonary resuscitation comprising a resuscitation device configured for autonomously performing cardiopulmonary resuscitation, a stimulation device configured for stimulating the nitric oxide synthase pathway in a patient in need thereof and a controller for controlling the resuscitation device and/or the stimulation device are presented. The combination of a resuscitation device and a stimulation device is advantageous in that the person under treatment, i.e. a person having suffered an ischemia receives both a significant flow of oxygenated blood (needed to reduced ischemia) as well as cardio and neuro-protoctive substances (note that production of these substances also requires the presence of oxygenated blood) to reduce reperfusion damage. As mentioned elsewhere the combination of CPR and additional stimulation of the endothelial function in a patient is advantageous in that it lowers the risk for reperfusion damage, which in turn raises the chance of survival for patients suffering from ischemia.

Advantageously the stimulation device may be configured for stimulating the nitric oxide synthase pathway by transmitting vibrations. It is advantageous to have the stimulation device emitting vibrations either when the stimulation device is in contact with the body of the patient. The vibrations are contemplated to travel through the body of the person to the intended areas, e.g. heart and other organs and body parts. The vibrations may be dampened through the body but this may be compensated for by altering the amplitude of the stimulation.

Advantageously the stimulation device may emit sound vibrations. This is contemplated to be advantageous in that sound is less prone to damping when traveling through the body, e.g. compared to light.

Advantageously the vibrations may have preferably a frequency in the interval from 1 Hz to 10 MHz, such as 24-27 kHz. Specific intervals will be discussed throughout the present specification.

Advantageously the stimulation device may emit electric or magnetic fields or energetic electromagnetic radiation. Subjecting organs to electric or magnetic fields is contemplated to lower perfusion damages by further stimulating the nitric oxide synthase pathway in a patient.

Advantageously the energetic electromagnetic radiation may be blue light. It is contemplated to be further advantageous to use blue light for stimulating the nitric oxide synthase pathway in a patient.

Advantageously the stimulation device may emit pulsed electric or magnetic files or pulsed energetic electromagnetic radiation. Advantageously the stimulation device may emit pulsed signals as this may in some instances be more effective than static fields. Also periods of rest, i.e. no stimulation, may allow the body to reinstate its normal operation.

Advantageously the stimulation device may emit power below 10 W/cm2, such as below 8 W/cm2, such as below 5 W/cm2, such as below 3 W/cm2, such as below 2, W/cm2, such as below 1 W/cm2. It is contemplated to be advantageous to emit signals at a relatively low power lever. Advantageously the stimulation device may emit power such that tissue damage does not occur. The emitted power level is such that local body heating is limited to below 1 degree Celsius and that clinical beneficial effects are significant. Typical power densities are around 1 W/cm2 for ultra sound and acoustic sound waves but upper level values of 2-3 W/cm2 may be used in some cases. The useable power density depends on the absorption coefficient of the radiation/vibration energy. It is contemplated to be advantageous to emit signals at a relatively low power level that still shows clinical benefit.

Advantageously the stimulation device may emit continuous or in a pulsed or burst mode with a specific duty cycle. It may be advantageous to have the apparatus delivering stimulation in a certain period of a first time following by a second period of time where no signal is emitted. Advantageously the duty cycle is between 1% and 90%, such as less than 50%.

Advantageously the stimulation device may be configured to stimulate the thorax and/or neck/head region of a patient in need thereof. It is advantageous to target the stimulation to areas where the nitric oxide synthase pathways in a patient are present.

Advantageously the stimulation device may be combined with or integrated with a device for application of mild hypothermia. Both devices may be either used invasively or non-invasively, e.g. intravenously by integration in a catheter.

A second aspect of the present invention relates to a method of operating an apparatus for performing cardiopulmonary resuscitation comprising a resuscitation device configured for autonomously performing cardiopulmonary resuscitation, a stimulation device configured for stimulating the nitric oxide synthase pathway in a patient in need thereof and a controller for controlling the resuscitation device and/or the stimulation device, the method may comprise the steps of operating the resuscitation device for delivering suitable resuscitation operations to a patient in need thereof, and operating the stimulation device so as to stimulate the endothelial function and nitric oxide synthase pathway in a patient in need thereof. It is very advantageous to combine the operation of a resuscitation device with the operation of a stimulation device and thereby increasing the effect due to the generation of relatively large flows of oxygenated blood by lowering the risk of perfusion damage. By coordinating the operation of such two devices the chance of saving lives of persons suffering from ischemia is raised.

Advantageously the method may further comprise the step of operating the stimulation device so as to stimulate the thorax and/or neck/head region of a patient in need thereof. It is advantageous to stimulate the area of the thorax and/or neck/head region of a patient as this is the areas where the largest perfusion damages may occur.

Advantageously the stimulation device may be configured to emit electric or magnetic fields or energetic electromagnetic radiation or in the alternative the stimulation device emit electric or magnetic fields or energetic electromagnetic radiation. The method may then comprise emitting electric or magnetic files or energetic electromagnetic radiation or in the alternative the stimulation device emitting electric or magnetic files or energetic electromagnetic radiation. This is contemplated to be advantageous as these types of radiation or fields stimulate the nitric oxide synthase pathway in a patient.

Instead of sound or ultra sound also mechanical vibrations with frequency below a few thousand hertz has been proposed to induce shear stress in the vessels and heart and even to promote dissolution of blood cloths in coronary arteries. There are also numerous papers and investigations on stimulation of these systems by (pulsed) electric or magnetic fields. Hence besides vigorous mechanical shaking there are more subtle, practical and more safe methods to promote these key endogenous processes during and after CPR. These transducers can be applied locally. It is however very important to combine these adjuncts with high quality CPR, preferably integrating these devices in an automated CPR device.

Advantageously the stimulation device further comprises a cooling device and the method comprises subjecting a patient in need thereof to hypothermia. The cooling of a patient could be advantageous as a lower temperature of the body of a person as this may help reduce complications when the heart have stopped.

Generally it is advantageous to provide a combination of mechanical and electro-magnetic adjuncts and an automated CPR device to improve CPR outcome. It is currently preferred that these adjuncts are based on sound, ultra sound and/or mechanical vibration, but other adjuncts may be envisioned. One object of the device and method is to promote both well oxygenated CPR induced blood flow, reduce ischemia related cell and organ damage, reduce blood clothing in the micro vasculature and reduce reperfusion damage.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates a device according to the present invention,

FIG. 2 is a schematic view of a thorax,

FIG. 3 is a schematic side view of a CPR pad,

FIG. 4 is a schematic bottom view of CPR pad,

FIG. 5 is a schematic view of an embodiment of a device including stimulation devices

FIGS. 6 and 7 schematically illustrate embodiments of a stimulation device, and

FIG. 8 schematically illustrates steps of a method according to the present invention.

### DETAILED DESCRIPTION OF EMBODIMENTS

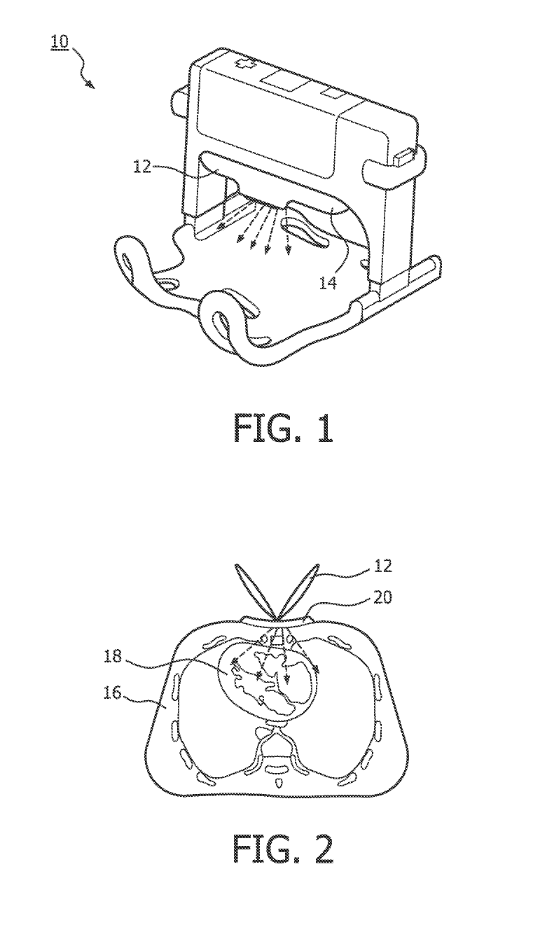

FIG. 1 schematically illustrates an embodiment of an automated device 10 where a transducer 12 is integrated in a CPR pad 14. In this way the heart and large vessels in the thorax of a patient being treated with the device 10 will be exposed to sound and/or vibrations in a physiologic important frequency/power range. Also an acoustic coupling medium may be introduced in between the transducer 12 (for example Aquaflex Ultrasonic gel pad) and the patient. The gel-pad, not illustrated here, also functions as a flexible contact surface between the CPR pad 14 and the chest of the victim/patient. The transducer may either emit, which is presently preferred, in the frequency range below 10 MHz (e.g. at 24-27 kHz, around 300 Hz) or at other suitable frequency or frequency interval. The (ultra) sound transducer may advantageously be of a Piezo type. The emitted power may advantageously be below 1 W/cm2. As mentioned above the stimulation device may emit power such that tissue damage does not occur. The emitted power level should be such that local body heating is limited to below 1 degree Celsius and that clinical beneficial effects are significant. Typical power densities are around 1 W/cm2 for ultra sound and acoustic sound waves but upper level values of 2-3 W/cm2 may be used in some cases. The useable power density depends on the absorption coefficient of the radiation/vibration energy. It is contemplated to be advantageous to emit signals at a relatively low power level that still shows clinical benefit.

The sound or ultra-sound may either be emitted continuous but may advantageously be in a pulsed mode with a certain duty cycle. The pulsation frequency can be in a wide range from 1 Hz up to a 10's of kHz, preferably in the range of 50 Hz to 500Hz. Duty cycles can be between 1% and 90% preferably less than 50%.

Instead of sound also vibration energy with a frequency higher than 1 Hz and lower than 10 kHz may be used, frequencies around 300 Hz is advantageous. The actuator in this case may be a small DC motor with an unbalanced load, there are other implementations possible. The frequency may be between 2 Hz and a few thousand hertz, preferably around 300 Hz.

FIG. 2 is a schematic drawing of cross section of the thorax 16 with indication of heart 18 and large vessels and sound/vibration transducer. The CPR pad 12 is in contact with the thorax 16 via a gel-pad 20. Via the CPR-pad 12 the transducer emits sound waves towards the heart 18 as indicated by the arrows.

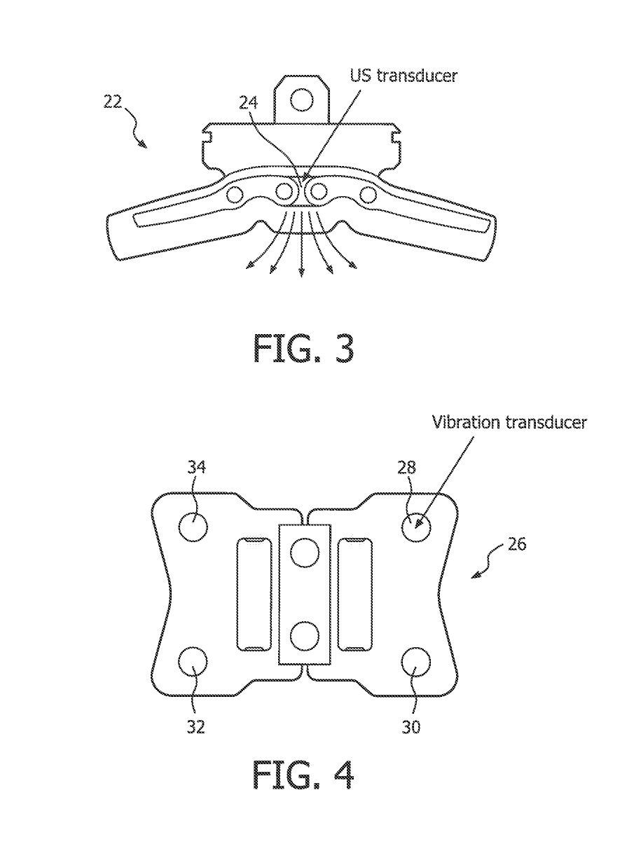

FIG. 3 is a schematic side view of a CPR pad 22 and separate sound or vibration transducer 24 in central element. The transducer 24 emit sound, preferably ultra sound, as indicated by the arrows, the specific path of the sound depends on the conditions in the thorax of the patient under treatment.

FIG. 4 is a schematic bottom view of CPR pad 26 with vibration transducers, 28, 30, 32 and 34 spread out over three parts of the pad 26.

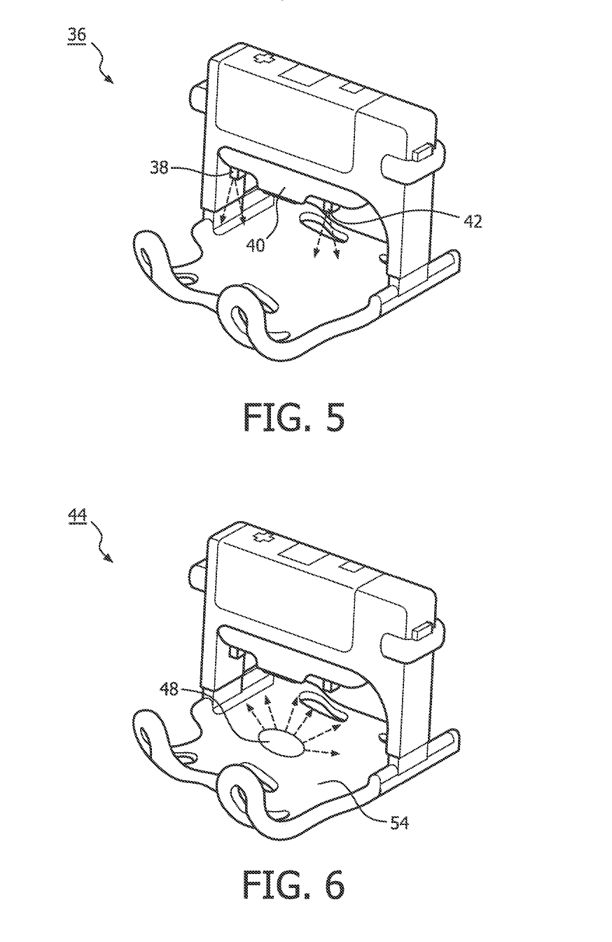

FIG. 5 is a schematic view of an embodiment of a device 36 with stimulation devices, 38 and 40, i.e. sound/vibration transducers mounted adjacent to the CPR pad 42 and fixed in the compression unit. Here the sound, ultra-sound or vibration transducer, or possibly transducers 38,40, are integrated in the compression unit adjacent to the CPR pad. Stimulation devices 38,40 can be brought in contact with the chest automatically or by a simple spring loaded system. Energies, frequencies etc. may be similar to the other embodiments described herein.

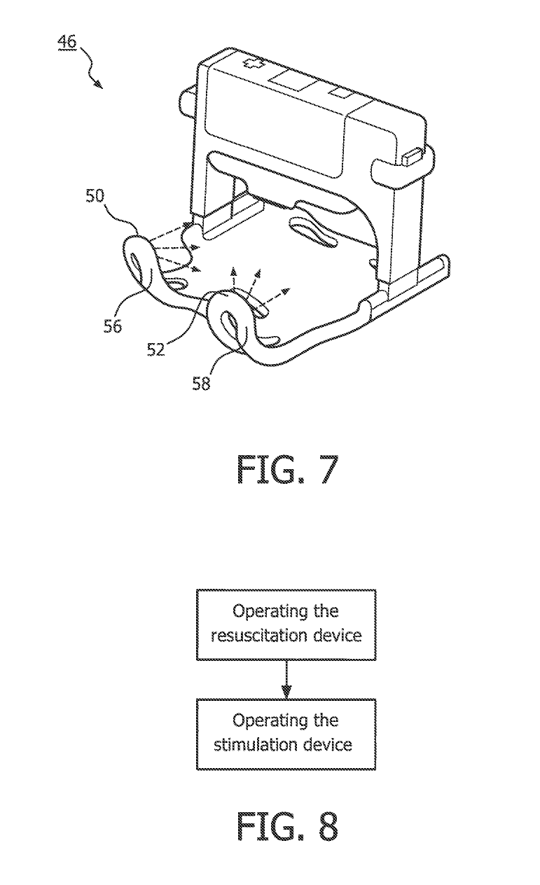

FIG. 6 and FIG. 7 schematically illustrates embodiments the stimulation device 44 and 46, here transducer 48, 50,52 is mounted either in the bottom plate 54 of the back board or in the shoulder stops 56, 58. The location in the shoulder stop 56,58 has advantages with respect to patient contact and location of contact area, clothes are less an issue in this area.

FIG. 8 schematically illustrates steps of a method 60 according to the present invention. The method 60 is a method of operating an apparatus, such as that described in relation to the above figures. The apparatus is an apparatus for performing cardiopulmonary resuscitation comprising a resuscitation device configured for autonomously performing cardiopulmonary resuscitation, a stimulation device configured for stimulating the nitric oxide synthase pathway in a patient in need thereof and a controller for controlling the resuscitation device and/or the stimulation device. The method 60 comprises the steps of operating 62 the resuscitation device for delivering suitable resuscitation operations to a patient in need thereof, and operating 64 the stimulation device so as to stimulate the endothelial function in a patient in need thereof. The method may be implemented as a computer program to be run on the controller for controlling the resuscitation device and/or the stimulation device.

While the invention has been illustrated and described in detail in the drawings and foregoing description, such illustration and description are to be considered illustrative or exemplary and not restrictive; the invention is not limited to the disclosed embodiments. Other variations to the disclosed embodiments including invasive stimulation devices can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An apparatus for performing cardiopulmonary resuscitation comprising:
a resuscitation device configured for autonomously performing cardiopulmonary resuscitation,
a stimulation device configured for stimulating the endothelial function including nitric oxide synthase pathway in a patient in need thereof, and
a controller for controlling the resuscitation device and/or the stimulation device wherein the stimulation device is configured for stimulating the endothelial function by transmitting vibrations.

2. (canceled)

3. The apparatus according to claim 1 wherein the stimulation device emits mechanical vibrations.

4. The apparatus according to claim 1 wherein the vibrations have a frequency in the interval from 1 Hz to 10 MHz, such as 24-27 kHz.

5. The apparatus according to claim 1, wherein the stimulation device emit electric or magnetic fields or energetic electromagnetic radiation.

6. The apparatus according to claim 5 wherein the energetic electromagnetic radiation is blue light.

7. The apparatus according to claim 5 wherein the stimulation device emit pulsed electric or magnetic files or pulsed energetic electromagnetic radiation.

8. The apparatus according to claim 1, wherein the stimulation device emits power below 10 W/cm2, such as below 8 W/cm2, such as below 5 W/cm2, such as below 3 W/cm2, such as below 2, W/cm2, such as below 1 W/cm2.

9. The apparatus according to claim 1, wherein the stimulation device emits continuous or in a pulsed mode with a specific duty cycle.

10. The apparatus according to claim 9, wherein the duty cycle is between 1% and 90%, such as less than 50%.

11. The apparatus according to claim 1, wherein the stimulation device in configured to stimulate the thorax and/or neck/head and/or abdomen region of a patient in need thereof.

12-15. (canceled)
